(19) United States
(12) Patent Application Publication
(10) Pub. No.: US 2020/0358332 A1
(43) Pub. Date: Nov. 12, 2020

(54) INTEGRATED STARTER GENERATOR AND HYBRID POWER SYSTEM

(71) Applicant: Jing-Jin Electric Technologies Co., Ltd., Beijing (CN)

(72) Inventors: Ping Yu, Beijing (CN); Zifu Wang, Beijing (CN); Haibin Wang, Beijing (CN)

(21) Appl. No.: 16/321,424

(22) PCT Filed: Jan. 20, 2017
(86) PCT No.: PCT/CN2017/071845

§ 371 Date: Jan. 28, 2019

(30) Foreign Application Priority Data
Jul. 29, 2016 (CN) 201610620592.6

(51) Int. Cl. H02K 7/00; H02K 1/27; H02K 21/24; H02K 3/47; H02K 7/18

(52) U.S. Cl. CPC H02K 7/006; H02K 1/2793; B60K 6/26; H02K 3/47; H02K 7/1815; H02K 21/24

(57) ABSTRACT

Disclosed is an integrated starter generator (ISG), comprising a stator (4) and a rotor (3). The stator and the rotor are oppositely arranged and are both provided with an annular iron core, a coil winding (121, 131) is arranged on the side, facing the rotor, of the iron core (120, 130) of the stator, a squirrel-cage conductor (123) or a plurality of permanent magnets (133) are arranged on the side, facing the stator, of the iron core (122, 132) of the rotor, and the rotor and the stator are spaced by a certain distance to form an air gap plane. In a hybrid power system installed with the integrated starter generator, a clutch (111) is arranged in an inner ring of the integrated starter generator in a nested manner. By arranging the clutch in the ISG, the axial length of the clutch is completely or partially covered by the axial length of the ISG, and thus the system space is reduced.

### TECHNICAL FIELD

The present disclosure relates to an integrated starter generator, and particularly relates to a mounting structure of the rotor and the stator in a motor. The present disclosure further relates to a hybrid power system.

### BACKGROUND

A motor in which a starter and a generator are integrated is an important component in electrification and hybrid-power oriented solutions for vehicles, which is mainly classified into belt-driven starter generator (BSG) and integrated starter generator (ISG).

An ISG is directly installed at the output end of the crankshaft of an internal combustion engine, which replaces the originally separated internal combustion engine starter and electric generator, and may also serve as an accessory power supply of the vehicle. As an electrification and hybrid-power oriented solution of vehicles, ISGs have the functions of internal combustion engine starting and stopping, electricity generation, braking, power assisting and so on, which facilitates vehicles in saving fuel oil consumption, and reduces the carbon pollution of exhausted gas. Moreover, compared with BSG, ISG does not use a belt, and thus eliminate the trouble in the maintenance of the belt.

In the conventional hybrid power systems that use ISGs, the ISG, the clutch and the driving motor are generally arranged in series in the direction of the transmission shaft, the advantage of which is the simple structure, while the disadvantages are a large axial space occupied, a relatively big mass and a relatively high manufacturing cost.

For example, in the Chinese invention patent “Electromagnetic Jaw Clutch And Double-Motor Hybrid System (— [symbol] [symbol] )” (CN103758889A), FIG. 4 of the description discloses a double-motor hybrid system, which comprises an ISG, an electromagnetic jaw clutch and a driving motor, all of which are arranged in series.

Moreover, in the prior art, whenever a hybrid power system of an internal combustion engine and a driving motor is involved, they are usually arranged in series.

For example, in the Chinese invention patent “Rotor Device Of Integrated Stater-Generator Motor And Rotor Working System (— [symbol] — [symbol] [symbol] )” (CN101964556B), FIG. 8 of the description discloses a hybrid power system, which comprises an engine, a crankshaft, a rotor device that connects to and rotates together with the crankshaft, a clutch that connects to the rotor device, and a gearbox that connects to the clutch, all of which are sequentially arranged in series.

In the Chinese invention patent “Hybrid Power System (— [symbol] )” (CN104315090A), FIG. 1 of the description discloses a hybrid power system, which comprises an internal combustion engine as the power supply A, a clutch and a motor as the power supply B, all of which are arranged in series.

### SUMMARY

Aiming at the above problems in the prior art, an object of the present disclosure is to provide an integrated starter generator (ISG) in which a clutch is provided, and the axial length of the ISG totally or partially absorbs the axial length of the clutch, thereby saving the space of the system.

Another object of the present disclosure is to provide a hybrid power system.

In order to achieve the above objects, the present disclosure employs the following technical solutions:

An integrated starter generator, comprising a stator and a rotor, the stator and the rotor are provided oppositely, each of the stator and the rotor is provided with a ring-shaped iron core, the iron core of the stator is provided with a coil winding on a side that faces the rotor, the iron core of the rotor is provided with a squirrel-cage conductor or a plurality of permanent magnets on a side that faces the stator, and the rotor and the stator are spaced by a predetermined distance to form an air gap plane.

Optionally, magnetic poles of the coil winding are distributed in an axial direction of the stator.

Optionally, magnetic poles of the permanent magnets are distributed in an axial direction of the rotor.

Optionally, the iron core of the stator is provided with tooth-slots for mounting of the coil winding on a side that faces the rotor, and the coil winding is a concentrated winding or a distributed winding.

Optionally, the iron core of the rotor is provided with tooth-slots for mounting the squirrel-cage conductor on a side that faces the stator, the squirrel-cage conductor is provided with two concentric short circuit rings, which are called an inner ring and an outer ring, and a plurality of conducting bars are evenly distributed between the two short circuit rings.

Optionally, the iron core of the rotor is provided with a plurality of recesses for mounting the permanent magnets on a side that faces the stator, and each of the permanent magnets is of a sector shape.

A hybrid power system, provided with an internal combustion engine and a driving motor, wherein the internal combustion engine connects to a crankshaft, an output end of the crankshaft connects to a clutch, the clutch connects to a main shaft of the driving motor, the main shaft of the driving motor connects to a gearbox, and the gearbox connects to a driving shaft; and the clutch comprises a movable contrate gear and a fixed contrate gear; wherein the hybrid power system is further provided with the above integrated starter generator, wherein the clutch is nested in the inner ring of the integrated starter generator.

Optionally, the rotor of the integrated starter generator is mounted and fixed on the fixed contrate gear of the clutch, and the stator of the integrated starter generator is mounted and fixed on a casing of the driving motor.

Optionally, each of the iron core of the rotor and the iron core of the stator is provided with a bed plate, and the bed plate are provided with a mounting hole, and is mounted and fixed by a bolt; and a cooling system in the driving motor also cools the stator.

Optionally, the clutch is an electromagnetic jaw clutch, and the fixed contrate gear surrounding the clutch is provided with a ring-shaped or sector-shaped electromagnet.

The integrated starter generator that employs the above structure configuration has the following advantages:

The ISG of the present disclosure is of a hollow ring shape, so the clutch can be arranged at its center.

The rotor and the clutch flywheel of the ISG are integrated, thereby saving the space, the weight and the manufacturing cost.

The present disclosure provides the clutch in the ISG, and the axial length of the ISG totally or partially absorbs the axial length of the clutch, thereby saving the space of the system.

In the present disclosure, because the stator of the ISG is mounted and fixed on a casing of the driving motor, a cooling system in the driving motor can also cool the stator, thereby optimizing the structure of the stator.

The present disclosure arranges the ISG at the output end of the crankshaft of the internal combustion engine and the outer side of the clutch, and has the functions of internal combustion engine starting and stopping, electricity generation, braking, power assisting and so on.

The above description is only an overview of the technical solutions of the present disclosure. In order to understand the technical means of the present disclosure more clearly, and to implement them according to the contents of the description, and in order to make the above and other objects, features and advantages of the present disclosure more fully understood, the particular embodiments of the present disclosure are provided below.

### BRIEF DESCRIPTION OF DRAWINGS

By reading the detailed description of the preferable embodiments below, various other advantages and benefits will become clear to a person skilled in the art. The drawings are only for the purpose of illustrating the preferable embodiments, and are not considered as limitation to the present disclosure. Furthermore, throughout the drawings, the same reference signs denote the same elements. In the drawings:

FIG. 1 is a schematic diagram of an integrated starter generator mounted on an oil electricity hybrid power vehicle;

FIG. 2 is a partial enlarged view of FIG. 1;

FIG. 3 is a perspective view of the first embodiment of the integrated starter generator;

FIG. 4 is an exploded view of the first embodiment of the integrated starter generator;

FIG. 5 is a front view of the stator employed in the first embodiment of the integrated starter generator;

FIG. 6 is a sectional view along the A-A in FIG. 5;

FIG. 7 is a left view of the stator employed in the first embodiment of the integrated starter generator;

FIG. 8 is a front view of the rotor employed in the first embodiment of the integrated starter generator;

FIG. 9 is a sectional view along the B-B in FIG. 5;

FIG. 10 is a left view of the rotor employed in the first embodiment of the integrated starter generator;

FIG. 11 is a perspective view of the second embodiment of the integrated starter generator; and

FIG. 12 is an exploded view of the second embodiment of the integrated starter generator.

In the drawings: 1. crankshaft output end; 2. fixed contrate gear; 3. rotor; 4. stator; 5. driven shaft; 6. movable contrate gear;
110. internal combustion engine; 111. clutch; 112. driving motor; 113. gearbox; 114. driving shaft; 115. differential; 116. driving wheel; 117. crankshaft;
120. iron core; 1201. tooth-slot; 121. coil winding; 122. iron core; 1221. tooth-slot; 123. squirrel-cage conductor;
130. iron core; 1301. tooth-slot; 131. coil winding; 132. iron core; and 133. permanent magnet.

### DETAILED DESCRIPTION

The exemplary embodiments of the present disclosure will be described in further detail below by referring to the drawings. Although the drawings illustrate the exemplary embodiments of the present disclosure, it should be understood that, the present disclosure can be implemented in various forms, and should not be limited by the embodiments illustrated herein. In contrast, the purpose of providing those embodiments is to more clearly understand the present disclosure, and to completely convey the scope of the present disclosure to a person skilled in the art.

### The First Embodiment

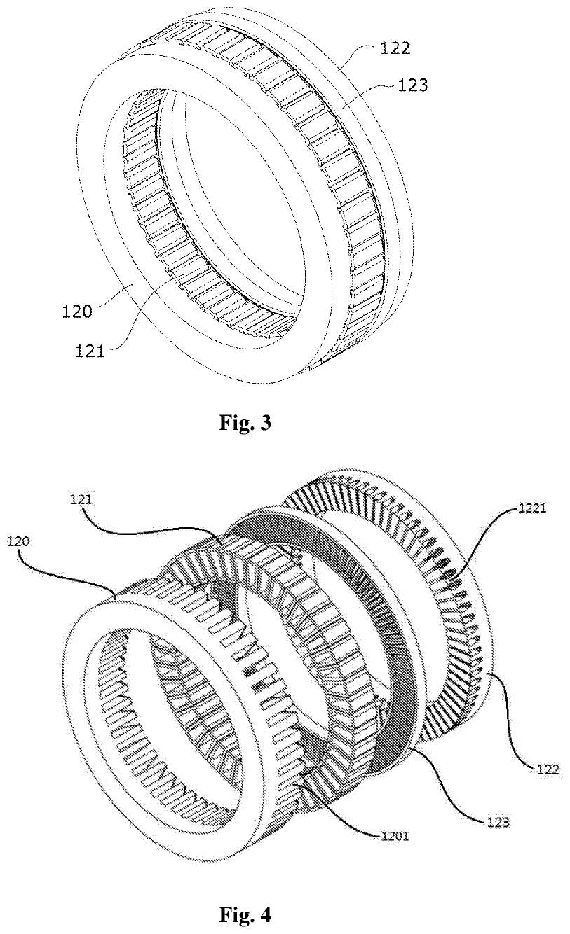

FIGS. 3, 4 and 5 show one of the embodiments of the present disclosure. In the present embodiment, an integrated starter generator (ISG) is provided, comprising a stator and a rotor, wherein the stator and the rotor are provided oppositely, each of the stator and the rotor is provided with a ring-shaped iron core, the iron core 120 of the stator is provided with a coil winding 121 on the side that faces the rotor, and the iron core 122 of the rotor is provided with a squirrel-cage conductor 123 on the side that faces the stator.

In the present embodiment, and the rotor and the stator are spaced by a predetermined distance to form an air gap plane. The air gap plane is perpendicular to the axial direction of the rotor and the stator.

The magnetic poles of the coil winding 121 are distributed in the axial direction of the stator.

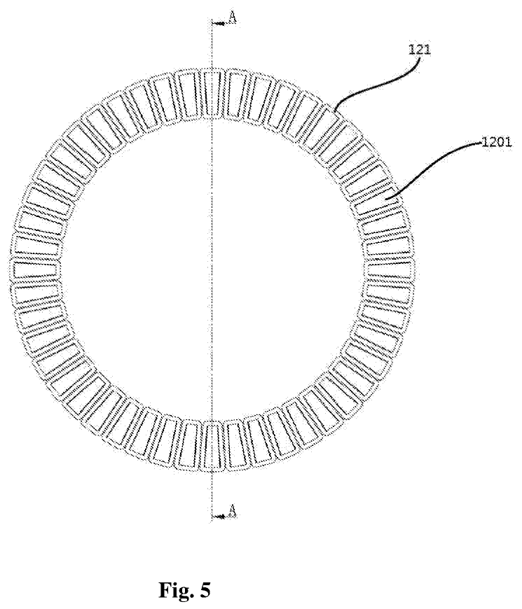

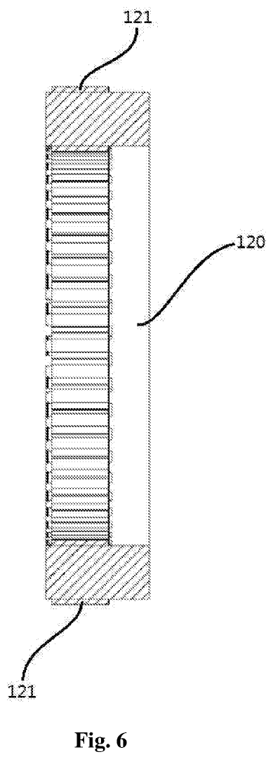

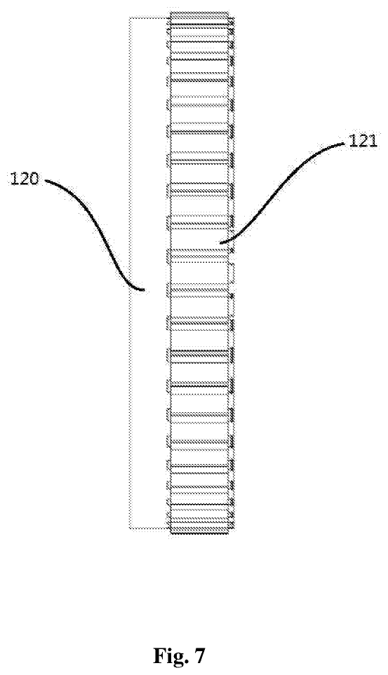

As shown in FIGS. 4 and 5, the iron core 120 of the stator is provided with tooth-slots 1201 for mounting the coil winding 121 on the side that faces the rotor, wherein the coil winding 121 is a concentrated winding.

The winding mode of the enameled wire in the stator is fractional slot concentrated winding; that is, the number of slots per pole per phase of the stator is a fraction less than one. The advantage of such a winding is that the size of the end of the winding is relatively small, which saves the consumption of the enameled wire, thereby reducing the cost.

Certainly, the coil winding 121 may also be a distributed winding.

The iron core 122 of the rotor is provided with tooth-slots 1221 for mounting the squirrel-cage conductor 123 on the side that faces the stator.

In order to improve efficiency, the opposing areas of the stator and the rotor are substantially equal.

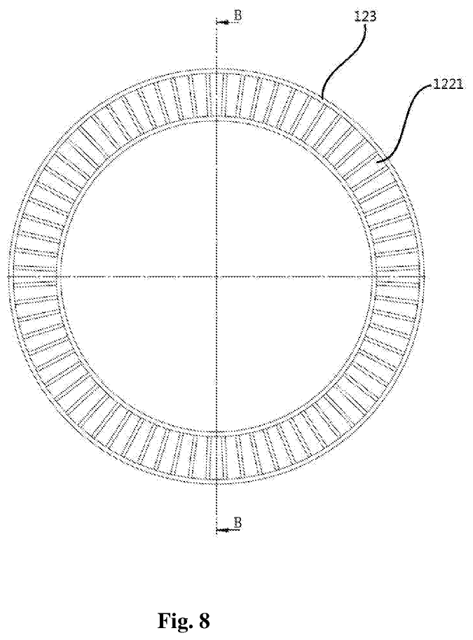

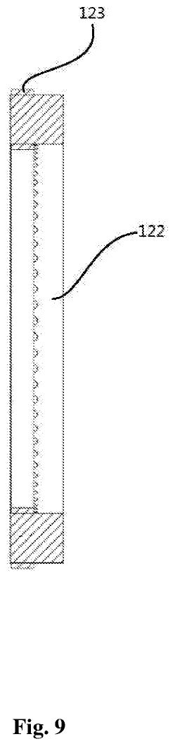

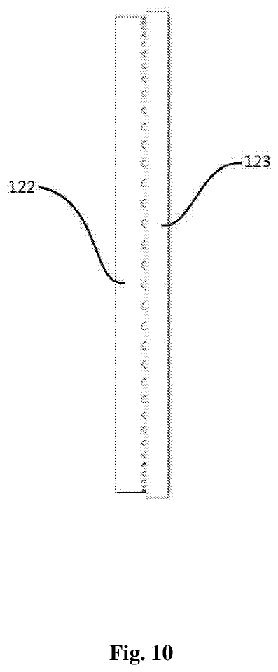

As shown in FIGS. 4 and 8, the squirrel-cage conductor 123 is provided with two concentric short circuit rings, which are called an inner ring and an outer ring, and a plurality of conducting bars are evenly distributed between the two short circuit rings. The squirrel-cage conductor of such structure is designed to adapt for the stator whose magnetic poles are distributed in the axial direction.

### The Second Embodiment

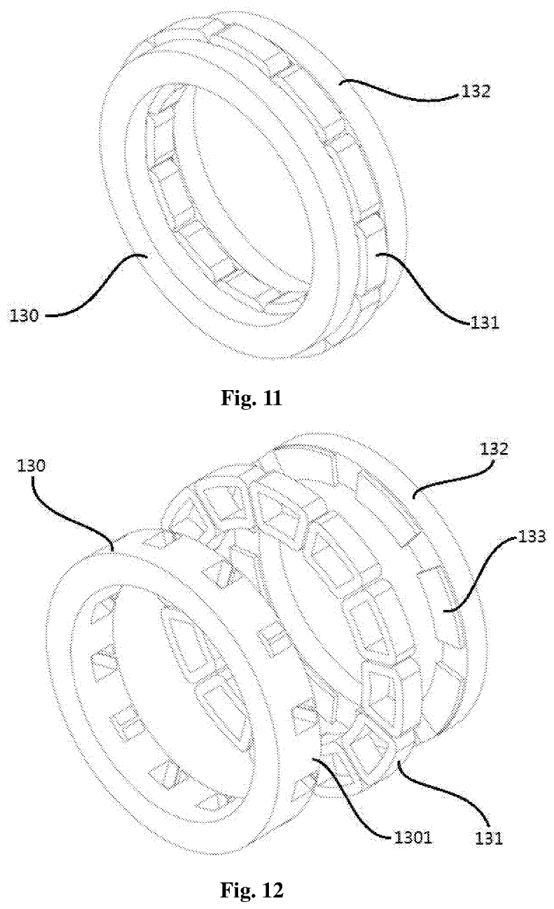

In the present embodiment, as shown in FIGS. 11 and 12, the iron core 132 of the rotor is provided with a plurality of permanent magnets 133 on the side that faces the stator.

The magnetic poles of the permanent magnets 133 are distributed in the axial direction of the rotor.

The permanent magnets, compared with the squirrel-cage conductor, can reduce the rotor loss.

The iron core 132 of the rotor is provided with a plurality of recesses for mounting the permanent magnets 133 on the side that faces the stator, and each of the permanent magnets 133 is of a sector shape.

The stator still employs the structure similar to that of the first embodiment. The iron core 130 of the stator is provided with tooth-slots 1301 for mounting the coil winding 131 on the side that faces the rotor, wherein the coil winding 131 is a concentrated winding.

### The Third Embodiment

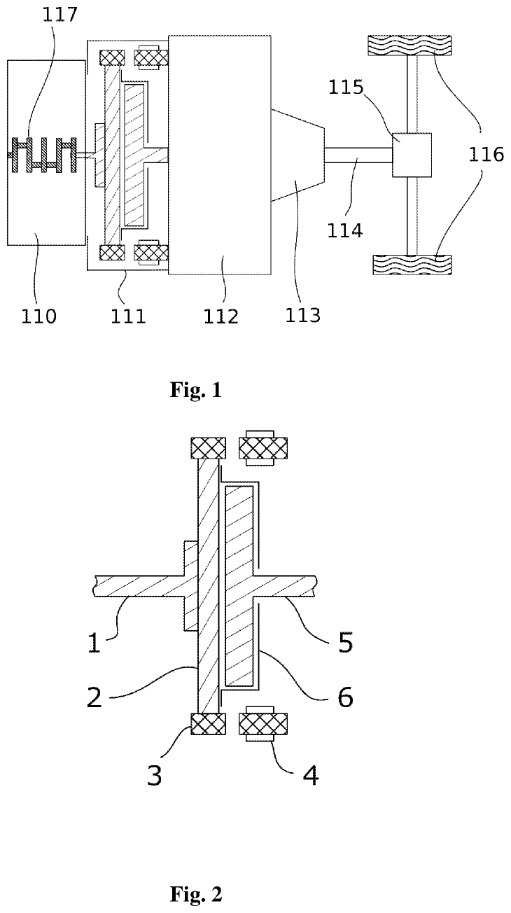

In the present embodiment, as shown in FIGS. 1 and 2, a hybrid power system is provided, which is provided with an internal combustion engine 110 and a driving motor 112, wherein the internal combustion engine 110 connects to a crankshaft 117, the output end of the crankshaft 117 connects to a clutch, the clutch connects to the main shaft of the driving motor 112, the main shaft of the driving motor 112 connects to a gearbox 113, the gearbox 113 connects to a driving shaft 114, the driving shaft 114 connects to a differential 115, and the differential 115 is provided on the main shaft of a driving wheel 116; the clutch comprises a fixed contrate gear 2 and a movable contrate gear 6; and the hybrid power system is further provided with the integrated starter generator, the clutch is nested in the inner ring of the integrated starter generator, and both of the fixed contrate gear 2 and the movable contrate gear 6 are located in the inner ring of the integrated starter generator.

In the present embodiment, the clutch is an electromagnetic jaw clutch, the fixed contrate gear 2 surrounding the clutch is provided with a ring-shaped or sector-shaped electromagnet, and correspondingly the movable contrate gear 6 may be provided with an armature.

The integrated starter generator employs the structure of the first embodiment or the second embodiment. The driving motor 112 is the driving motor of the driving shaft 114, and a driven shaft 5 is provided between the main shaft of the driving motor 112 and the clutch.

The rotor 3 of the integrated starter generator is mounted and fixed on the fixed contrate gear 2 of the clutch, and the stator 4 of the integrated starter generator is mounted and fixed on the casing of the driving motor 112.

Because the stator 4 is mounted and fixed on the casing of the driving motor 112, a cooling system in the driving motor 112 can also cool the stator 4, thereby optimizing the structure of the stator.

The rotational speeds of the rotor 3 and of the movable contrate gear 6 are always the same.

The installation of the integrated starter generator is required to satisfy that: during engaging and disengaging between the fixed contrate gear 2 and the movable contrate gear 6 of the clutch, the rotor 3 and the stator 4 have a proper gap therebetween.

In order to install the rotor 3 and the stator 4, such a structure may be employed that, each of the iron core of the rotor 3 and the iron core of the stator 4 is provided with a bed plate, and the bed plate is provided with a mounting hole, and is mounted and fixed by a bolt (not shown).

The bed plate may be an ear plate, which extends toward the inner ring or the outer ring based on the iron core. The bed plate may also be a bezel, which extends toward the inner ring or the outer ring based on the iron core.

Optionally, each of the iron core of the rotor 3 and the iron core of the stator 4 is provided with a plurality of screwed holes, through which fixing bolts are directly mounted on the iron core, and then connect to the movable contrate gear 6 and the casing of the driving motor 112 respectively.

The above descriptions are merely preferable embodiments of the present disclosure, and are not intended to limit the protection scope of the present disclosure. Any modifications, equivalent substitutions or improvements that are made within the spirit and principle of the present disclosure are all included in the protection scope of the present disclosure.

1. An integrated starter generator, comprising a stator and a rotor, wherein the stator and the rotor are provided oppositely, each of the stator and the rotor is provided with a ring-shaped iron core, the iron core of the stator is provided with a coil winding on a side that faces the rotor, the iron core of the rotor is provided with a squirrel-cage conductor or a plurality of permanent magnets on a side that faces the stator, and the rotor and the stator are spaced by a predetermined distance to form an air gap plane.

2. The integrated starter generator according to claim 1, wherein magnetic poles of the coil winding are distributed in an axial direction of the stator.

3. The integrated starter generator according to claim 1, wherein magnetic poles of the permanent magnets are distributed in an axial direction of the rotor.

4. The integrated starter generator according to claim 1, wherein the iron core of the stator is provided with tooth-slots for mounting of the coil winding on a side that faces the rotor, and the coil winding is a concentrated winding or a distributed winding.

5. The integrated starter generator according to claim 1, wherein the iron core of the rotor is provided with tooth-slots for mounting the squirrel-cage conductor on a side that faces the stator, the squirrel-cage conductor is provided with two concentric short circuit rings, which are called an inner ring and an outer ring, and a plurality of conducting bars are evenly distributed between the two short circuit rings.

6. The integrated starter generator according to claim 1, wherein the iron core of the rotor is provided with a plurality of recesses for mounting of the permanent magnets on a side that faces the stator, and each of the permanent magnets is of a sector shape.

7. A hybrid power system, provided with an internal combustion engine and a driving motor, wherein the internal combustion engine connects to a crankshaft, an output end of the crankshaft connects to a clutch, the clutch connects to a main shaft of the driving motor, and the clutch comprises a movable contrate gear and a fixed contrate gear; wherein the hybrid power system is further provided with the integrated starter generator according to claim 1, wherein the clutch is nested in the inner ring of the integrated starter generator.

8. The hybrid power system according to claim 7, wherein the rotor of the integrated starter generator is mounted and fixed on the fixed contrate gear of the clutch, and the stator of the integrated starter generator is mounted and fixed on a casing of the driving motor.

9. The hybrid power system according to claim 8, wherein each of the iron core of the rotor and the iron core of the stator is provided with a bed plate, and the bed plate is provided with a mounting hole, and is mounted and fixed by a bolt; and a cooling system in the driving motor also cools the stator.

10. The hybrid power system according to claim 8, wherein the clutch is an electromagnetic jaw clutch, and the fixed contrate gear surrounding the clutch is provided with a ring-shaped or sector-shaped electromagnet.
